(19) United States
(12) Patent Application Publication
(10) Pub. No.: US 2013/0310472 A1
(43) Pub. Date: Nov. 21, 2013

(54) USE OF DI(2-ETHYLHEXYL)TEREPHTHALATE (DEHT) IN FOAMABLE PVC FORMULATIONS

(71) Applicants: Hinnerk Gordon Becker, Essen (DE); Michael Grass, Haltern am See (DE); Andre Huber, Marl (DE)

(72) Inventors: Hinnerk Gordon Becker, Essen (DE); Michael Grass, Haltern am See (DE); Andre Huber, Marl (DE)

(73) Assignee: Evonik Oxeno GmbH, Marl (DE)

(21) Appl. No.: 13/988,873

(22) PCT Filed: Oct. 31, 2011
(86) PCT No.: PCT/EP11/69135

§ 371 Date: Aug. 1, 2013

(30) Foreign Application Priority Data
Nov. 24, 2010 (DE) 10 2010 061 866.7

(51) Int. Cl. C08J 9/00; C08K 13/02; C08K 5/12

(52) U.S. Cl. CPC C08J 9/0023; C08K 5/12; C08K 13/02
USPC 521/73; 521/145

(57) ABSTRACT

The invention relates to a foamable composition containing a polymer selected from the group consisting of polyvinyl chloride, polyvinylidene chloride, polyvinyl butyrate, polyalkyl(meth)acrylate and copolymers thereof, a foam former and/or foam stabilizer and di-2-ethylhexyl terephthalate as plasticizer.

The invention further relates to foamed mouldings and to use of the foamable composition for floor coverings, wall coverings or artificial leather.

The invention relates to a foamable composition containing at least one polymer selected from the group consisting of polyvinyl chloride, polyvinylidene chloride, polyvinyl butyrate, polyalkyl(meth)acrylate and copolymers thereof, a foam former and/or foam stabilizer and di-2-ethylhexyl terephthalate (DENT) as plasticizer.

Polyvinyl chloride (PVC) is one of the most important commercial polymers. It is used in a wide variety of applications, in the form of plasticized PVC as well as unplasticized PVC. Examples of important applications are cable wraps, floor coverings, wall coverings and also frames for plastics windows. To enhance the elasticity, plasticizers are added to the PVC. These customary plasticizers include for example phthalic esters such as di-2-ethylhexyl phthalate (DEHP), diisononyl phthalate (DINP) and diisodecyl phthalate (DIDP).

Many PVC articles are typically made to include layers of foam in order that the weight of the products and thus also the costs may be reduced by virtue of the lower material requirements. The user of a foamed product can benefit from superior structureborne sound insulation in the case of floor coverings for example. The quality of foaming within the formulation is dependent on many components in that the type of PVC used and the plasticizer play an important part as well as foam former type and quality. Good foaming is known to be achievable in particular when the formulation recipe includes at least a proportion of fast-gelling plasticizers (known as fast-gellers) such as BBP (benzyl butyl phthalate). In many cases, however, the sole use of DINP has become established for cost as well as other reasons.

In connection with the controversy surrounding ortho-phthalates in children's toys, various statutory measures have been passed to regulate this group of substances, and further tightening of the legislation cannot be ruled out in principle. Therefore, the industry is working intensively on the development of novel plasticizers free of ortho-phthalate that are toxicologically unconcerning and technically equivalent to the phthalates. Terephthalic esters such as di-2-ethylhexyl terephthalate (DEHT) for example or cyclohexane acid esters such as diisononyl 1,2-cyclohexanedicarboxylate (DINCH) have recently been discussed as possible alternatives.

EP 1 505 104 describes a foamable composition containing isononyl benzoate as plasticizer. The use of isononyl benzoates as plasticizer, however, has the appreciable disadvantage that isononyl benzoates are very volatile and therefore escape from the polymer during processing and also with increasing storage and service time. This presents appreciable problems with applications in interiors in particular for example. Therefore, isononyl benzoates are frequently used in the prior art as plasticizer admixtures with customary other plasticizers such as phthalic esters for example. Isononyl benzoates are also used as fast-gellers. Furthermore, the use of fast-gellers such as BBP or else isononyl benzoates would cause an excessively high increase in the viscosity of the corresponding plastisol over time.

Further prior art plasticizers for use in PVC include certain alkyl terephthalates. EP 1 808 457 A1 describes the use of dialkyl terephthalates characterized in that the alkyl radicals have a longest carbon chain of four or more carbon atoms and five carbon atoms per alkyl radical in total. Terephthalic esters having four to five carbon atoms in the longest carbon chain of the alcohol are said to be very useful as fast-gelling plasticizers for PVC. This is also said to be surprising particularly because theretofore such terephthalic esters were regarded in the prior art as incompatible with PVC. The reference in question further states that dialkyl terephthalates are also useful in chemically or mechanically foamed layers or in compact layers/primers. But even these plasticizers have to be classified as relatively volatile fast-gellers, and so the problems mentioned above continue to persist in principle.

The abovementioned di-2-ethylhexyl terephthalate (DEHT) has been known for decades as a plasticizer for PVC and other polymers. Performance data concerning this product are available in numerous publications, including particularly in the form of conference reports and presentations. By way of example there may be mentioned the publication by Don Beeler (“Terephthalate esters, a new class of plasticizers for poly(vinyl chloride”) in Technical Papers—Society of Plastics Engineers (1976), 22 613-15, and also the presentation by M. Stimpson and M. Holt on the PVC formulation conference in March 2009 in Cologne entitled: “DEHT: an Alternative to ortho-Phthalates in flexible PVC Compound Applications”. This is where attention was also drawn for example to the lower gellability of DEHT, compared with DINP. Test results concerning this product have also been presented at numerous other conferences. However, nothing has been disclosed to date about the suitability of DEHT as a plasticizer for or in foamable compositions.

However, it must be assumed that the distinctly worse gelling behaviour of DINCH compared with DINP would have an adverse effect on foamability, i.e. the percentage foaming per unit time at a given temperature. This must also be concluded from a statement in the familiar textbook “Handbook of Vinyl Formulating”, Second Edition, is John Wiley (ISBN 978-0-471-71046-2), p. 384, that “ . . . with slower fusing plasticizers . . . , it may be necessary to . . . run at higher oven temperatures” to effect foaming. Higher temperatures, however, are disadvantageous for the processor since they raise energy costs and also cause the product to discolour through thermal ageing.

The problem addressed by the invention is accordingly that of identifying such plasticizers as exhibit foaming properties equivalent to those of DINP even without the use of fast-gellers, and therefore no longer exhibit the abovementioned difficulties of the faster viscosity increase for the corresponding plastisols over time (storage stability) and the distinctly higher volatility. Nonetheless, these plastisols should also be readily processible, i.e. have a viscosity which is similar to that of the current standard DINP, since otherwise increased diluent would again have to be added to adjust the viscosity of plastisol and thereafter the diluent would have to be thermally expelled again in the course of processing which is economically and ecologically disadvantageous.

This technical problem is solved by a foamable composition containing at least one polymer selected from the group consisting of polyvinyl chloride, polyvinylidene chloride, polyvinyl butyrate, polyalkyl(meth)acrylate and copolymers thereof, a foam former and/or foam stabilizer and di-2-ethylhexyl terephthalate (DEHT) as plasticizer.

Compositions containing di-2-ethylhexyl terephthalate (DEHT) and a foam former or a foam stabilizer were very surprisingly found to be suitable for production of foams or foamed layers which, compared with corresponding DINP-containing compositions, exhibit distinctly greater expansion behaviour with unchanged temperature and residence time even though the gelling rate has been reduced. This makes it possible to reduce either the processing temperature or, if the temperature is kept the same, the residence time in the oven, and this leads to a product output per unit time which is higher and hence advantageous for the processor. This is surprising because this is at odds with established textbook opinion (e.g. “Handbook of Vinyl Formulating”, Second Edition, John Wiley (ISBN 978-0-471-71046-2), page 384) that better-gelling plasticizers also lead to higher expansion rates during foaming.

A further advantage is that the foamable compositions can be processed at lower temperatures and therefore also exhibit a distinctly lower yellowness index. Even if the processing temperature is not changed, the yellowness index of the sheets of foam which are obtained from the compositions of the invention is lower than that of a corresponding DINP recipe, so that less white pigment can be used here to hide the yellowness.

It must further be noted that di-2-ethylhexyl terephthalate of the invention is distinctly less volatile than isononyl benzoates used in foamable compositions of the prior art. The possibility of dispensing with generally volatile fast-gellers also facilitates the use for applications in interiors, since the plasticizers in the composition of the invention are less volatile and are less prone to escape from the plastic.

At least one polymer present in the foamable composition is selected from the group consisting of polyvinyl chloride, polyvinylidene chloride, polyvinyl butyrate, polyalkyl(meth)acrylate and copolymers thereof.

In one further preferred embodiment, the polymer may be a copolymer of vinyl chloride with one or more monomers selected from the group consisting of vinylidene chloride, vinyl butyrate, methyl(meth)acrylate, ethyl(meth)acrylate or butyl(meth)acrylate.

The amount of diisononyl 1,2-cyclohexanedicarboxylate in the foamable composition is preferably in the range from 5 to 150 parts by mass, more preferably in the range from 10 to 100 parts by mass, even more preferably in the range from 10 to 80 parts by mass and most preferably in the range from 15 to 90 parts by mass per 100 parts by mass of polymer.

The foamable composition may optionally contain further additional plasticizers other than di-2-ethylhexyl terephthalate.

The solvation and/or gelling capacity of additional plasticizers can be higher than, the same as or lower than that of the di-2-ethylhexyl terephthalate of the invention. The mass ratio of employed additional plasticizers to the employed di-2-ethylhexyl terephthalate of the invention is particularly between 1:10 and 10:1, preferably between 1:10 and 8:1, more preferably between 1:10 and 5:1 and even more preferably between 1:10 and 1:1.

Additional plasticizers are particularly esters of ortho-phthalic acid, of isophthalic acid, of terephthalic acid (other than di-2-ethylhexyl terephthalate), of cyclohexanedicarboxylic acid, of trimellitic acid, of citric acid, of benzoic acid, of isononanoic acid, of 2-ethylhexanoic acid, of octanoic acid, of 3,5,5-trimethylhexanoic acid and/or esters of butanol, pentanol, octanol, 2-ethylhexanol, isononanol, decanol, dodecanol, tridecanol, glycerol and/or isosorbide and also their derivatives and mixtures. It may be preferable to use citric esters such as for example acetyl tributyl citrate or benzoates.

In principle, the foamable composition can be foamed up chemically or mechanically. Chemical foaming here is to be understood as meaning that the foamable composition contains a foam former which, by thermal decomposition at elevated temperature, forms gaseous components which then effectuate the foaming up.

It is therefore further preferable for the foamable composition of the invention to contain a foam former. This foam former can be a compound which evolves gas bubbles and optionally contains a kicker. Kicker refers to metal compounds which catalyse the thermal decomposition of the gas bubble evolver component, and cause the foam former to decompose by evolving a gas and the foamable composition to be foamed up. Foam formers are also termed blowing agents. As component evolving gas bubbles it is preferable to use a compound which, on exposure to heat, decomposes into gaseous constituents which bring about expansion of the composition. One example of a typical representative of such compounds is azodicarbonamide, which releases predominantly N₂ and CO on thermal decomposition. The decomposition temperature of the blowing agent can be lowered by the kicker.

A further useful blowing agent is p,p′-oxybis(benzenesulphonyl hydrazide), also called OBSH. It has a lower decomposition temperature compared with azodicarbonamide. Further information on blowing agents is discernible from the “Handbook of Vinyl Formulating”, Second Edition, John Wiley (ISBN 978-0-471-71046-2), pages 379 ff. The blowing agent is particularly preferably azodicarbonamide.

In contradistinction to chemical foaming, the operation of mechanical foaming involves the foam being produced by introducing a gas, preferably air, into the composition by vigorous stirring, similarly to the production of whipped cream, to produce what is known as beaten foam. The foam is then for example applied to a support and subsequently fixed by the high processing temperature. To prevent the decomposition of foam bubbles over time, it is preferable to use foam stabilizers in mechanical foams. Foam stabilizers present in the composition of the invention can be commercially available foam stabilizers. Such foam stabilizers can be based for example on silicone or soap and are for example available under the brand names BYK (from Byk-Chemie). These are used in amounts of 1 to 10, preferably 1 to 8 and more preferably 2 to 4 parts by mass per 100 parts by mass of polymer. Further details concerning useful foam stabilizers (e.g. calcium dodecylbenzenesulphonate) are mentioned in DE 10026234 C1 for example.

In principle, the foamable compositions of the invention can be for example plastisols obtainable by mixing emulsion or microsuspension PVC with liquid components such as plasticizers.

It is further preferable for the foamable composition to contain an emulsion PVC. It is very particularly preferable for the foamable composition of the invention to include an emulsion PVC that has a molecular weight in terms of the K-value (Fikentscher constant) in the range from 60 to 95 and more preferably in the range from 65 to 90.

The foamable composition may further preferably contain additional additives, more particularly selected from the group consisting of fillers, pigments, thermal stabilizers, antioxidants, viscosity regulators, (further) foam stabilizers, flame retardants, adhesion promoters and lubricants.

One of the functions of thermal stabilizers is to neutralize hydrochloric acid eliminated during and/or after the processing of the PVC, and to inhibit thermal degradation of the polymer. Thermal stabilizers which can be used are any of the customary PVC stabilizers in solid or liquid form, for example those based on Ca/Zn, Ba/Zn, Pb, Sn or organic compounds (OBSs), and also acid-binding phyllosilicates such as hydrotalcite. The mixtures of the invention may contain from 0.5 to 10, preferably from 1 to 5 and more preferably from 1.5 to 4 parts by mass of thermal stabilizers per 100 parts by mass of polymer.

Both organic and inorganic pigments can be used for the purposes of the present invention. The pigment content is between 0.01% to 10% by mass, preferably 0.05% to 5% by mass and more preferably 0.1% to 3% by mass per 100 parts by mass of polymer. Examples of inorganic pigments are CdS, CoO/Al₂O₃, Cr₂O₃. Examples of known organic pigments are azo dyes, phthalocyanine pigments, dioxazine pigments and also aniline pigments.

Viscosity-lowering reagents which can be used comprise aliphatic or aromatic hydrocarbons, but also carboxylic acid derivatives such, for example, 2,2,4-trimethyl-1,3-pentanediol diisobutyrate, known as TXIB (from Eastman). The latter is also very readily replaced by isononyl benzoate, because intrinsic viscosity is similar. Owing to the similar viscosity of plastisols based on the composition of the invention the additional consumption of viscosity-lowering reagents is rather low. Viscosity-lowering reagents are added in proportion of 0.5 to 30, preferably 1 to 20 and more preferably 2 to 15 parts by mass per 100 parts by mass of polymer. Specific viscosity-lowering additives are available for example under the trade name Viskobyk (from Byk-Chemie).

The present invention further provides for the use of the foamable composition for floor is coverings, wall coverings or artificial leather. The invention yet further provides a floor covering containing the foamable composition of the invention, a wall covering containing the foamable composition of the invention or artificial leather containing the foamable composition of the invention.

Di-2-ethylhexyl terephthalate (DEHT) is produced in industry either by transesterifying dimethyl terephthalate with the high-volume oxo process alcohol 2-ethylhexanol or by esterifying terephthalic acid with this alcohol. A further possible production route is offered by the reaction of recycled PET material with 2-ethylhexanol. Corresponding methods of production are described for example in WO 2008094396, US 2007038001 or in Huagong Jinzhan (2008), 27(1), 143-146. DEHT is commercially available for example from the American producer Eastman Chemical under the name of Eastman 168.

The foamable composition of the invention is obtainable in various ways. Generally, however, the composition is obtained by intensively mixing all components in a suitable mixing container. Here the components are preferably added in succession (see also E. J. Wickson, “Handbook of PVC Formulating”, John Wiley and Sons, 1993, p. 727).

The foamable composition of the invention can be used for production of foamed mouldings containing at least a polymer selected from the group polyvinyl chloride or polyvinylidene chloride or copolymers thereof.

Examples of foamed products of this type are artificial leather, floor coverings or wall coverings, more particularly the use of foamed products in cushion vinyl flooring and wall coverings.

The foamed products from the foamable composition of the invention are obtained by initially applying the foamable composition to a support or a further polymeric layer and foaming the composition before or after application and finally subjecting the applied and/or foamed composition to thermal processing.

Unlike mechanical foam, chemical foams are only formed in the course of processing, generally in a gelling tunnel, i.e. the still unfoamed composition is applied to the support, preferably by spread coating. With this mode of performing the process, profiling the foam can be achieved through selective application of inhibitor solutions, for example via a rotary screen printing rig. In those places where the inhibitor solution was applied plastisol expansion during processing only takes place with delay, if at all. In commercial practice, chemical foaming is distinctly more popular than mechanical foaming. Further information concerning chemical and mechanical foaming is discernible from, for example, E. J. Wickson, “Handbook of PVC Formulating”, 1993, John Wiley & Sons. Optionally, profiling can also be achieved subsequently through what is known as mechanical embossing using an embossing roll for example.

Both processes can utilize support materials that remain firmly attached to the foam produced, examples being woven or nonwoven webs. Similarly, the supports may also be merely temporary supports, from which the foams produced can be removed again as layers of foam. Such supports can be, for example, metal belts or release paper (Duplex paper). Another polymeric layer, if appropriate one which has previously been completely or partially (=pre-gelled) gelled, may also function as a support. This method is practised particularly in the case of CV floor coverings constructed of two or more layers.

In both cases, the final thermal treatment takes place in what is known as a gelling tunnel, generally an oven, through which the layer applied to the support and composed of the composition of the invention is passed, or into which the support to which the layer has been applied is introduced for a short period. The final thermal treatment serves to solidify (gel) the foamed layer. In the case of chemical foaming, the gelling tunnel may be combined with an apparatus serving to produce the foam. It is possible, for instance, to use only one gelling tunnel, in the upstream portion of which, at a first temperature, the foam is produced chemically by decomposition of a gas-forming component, this foam being converted in the downstream portion of the gelling tunnel, at a second temperature which is preferably higher than the first temperature, into the finished or semi-finished product. Depending on the composition, it is also possible for gelling and foaming to take place simultaneously at a single temperature. Typical processing temperatures (gelling temperatures) are in the range from 130 to 280° C. and preferably in the range from 150 to 250° C. In the preferred manner of gelling, the foamed composition is treated at the gelling temperatures mentioned for a period of 0.5 to 5 minutes, preferably for a period of 0.5 to 3 minutes. In the case of processes which operate continuously, the duration of the heat treatment here may be adjusted via the length of the gelling tunnel and the speed at which the support with the foam on top passes therethrough. Typical foaming temperatures (chemical foam) are in the range from 160 to 240° C. and preferably in the range from 180 to 220° C.

In the case of multilayered systems, the shape of the individual layers is generally first fixed by what is known as pre-gelling of the applied plastisol at a temperature below the decomposition temperature of the blowing agent, and after this other layers (e.g. an overlayer) may be applied. Once all the layers have been applied, a higher temperature is used for the gelling—and also for the foam-forming process in the case of chemical foaming. The desired profiling can also be extended to the overlayer by this procedure.

The foamable compositions of the invention are advantageous over the prior art in that they are either more rapidly processible at unchanged temperatures or alternatively can be processed at lower temperatures, and hence appreciably improve the efficiency of the manufacturing operation for PVC foams. Furthermore, the plasticizers used in the PVC foam are less volatile than, for example, the isononyl benzoates mentioned in the prior art, and hence the PVC foam is also particularly suitable for interior applications in particular.

### Analysis:

### 1. Determination of Purity

GC purity of the ester produced is determined using a 6890N GC automat from Agilent Technologies with a DB-5 column (length: 20 m, internal diameter: 0.25 mm, film thickness 0.25 μm) from J&W Scientific and a flame ionization detector under the following general conditions:

| | |
|---|---|
| Initial oven temperature: 150° C. | Final oven temperature: 350° C. |
| (1) Heating rate 150-300° C.: 10 K/min | (2) Isothermal: 10 min at |
| | 300° C. |
| (3) Heating rate 300-350° C.: 25 K/min | |
| Total run time: 27 min | |
| Injection block inlet temperature: | Split ratio: 200:1 |
| 300° C. | |
| Split flux: 121.1 ml/min | Total flux: 124.6 ml/min |
| Carrier gas: helium | Injection volume: 3 microlitres |
| Detector temperature: 350° C. | Burner gas: hydrogen |
| Hydrogen flow rate: 40 ml/min | Air flow rate: 440 ml/min |
| Makeup gas: helium | Fluorite makeup gas: 45 ml/min |

The gas chromatograms obtained are evaluated manually against available comparative substances, purity is reported in area percent. Owing to high end contents of >99.7% for target substance, the likely error due to no calibration for the particular sample substance is low.

### 2. Determination of Plastisol Viscosity

PVC plastisol viscosity was measured using a Physica MCR 101 (from Anton-Paar) in the rotary mode and with the “Z3” measuring system (DIN 25 mm).

The plastisol was initially homogenized by hand in the mixing container using a spatula, then introduced into the measuring system and measured isothermally at 25° C. The following points were targeted during measurement:

1. A pre-shear of 100 s⁻¹ for a period of 60 s, during which no values were recorded (to level any thixotropic effects).
2. A downward ramp of the shear rate beginning at 200 s⁻¹ and ending at 0.1 s⁻¹, divided into a logarithmic series of 30 steps each of 5 seconds' measuring point duration.

The measurements were generally carried out (unless otherwise stated) following a 24 h storage/ripening of the plastisols. The plastisols were stored at 25° C. between the measurements.

### 3. Determination of Gelling Rate

Plastisol gelling behaviour was investigated in a Physica MCR 101 in oscillatory mode with a plate-plate measuring system (PP25) operated under shear stress control. An additional heating hood was connected to the instrument to achieve the best possible distribution of heat.

### Test Parameters:

Mode: temperature gradient (temperature ramp linear)
   starting temperature: 25° C.
   end temperature: 180° C.
   heating/cooling rate: 5 K/min
   oscillation frequency: 4-0.1 Hz ramp (logarithmic)
   circular frequency omega: 10 1/s
   number of measuring points: 63
   measuring point duration: 0.5 min
   no automatic gap readjustment
   constant measuring point duration
   gap width 0.5 mm

### Measurement Procedure:

A spatula was used to apply a drop of the plastisol to be measured, free from air bubbles, to the lower plate of the measuring system. Care was taken here to ensure that some plastisol could exude uniformly out of the measuring system (not more than about 6 mm overall) after the measuring system had been closed. The heating hood was subsequently positioned over the sample and the measurement started.

What was determined is the so-called complex viscosity of the plastisol as a function of the temperature. Onset of gelling was identifiable by sudden marked rise in complex viscosity. The earlier the onset of this rise in viscosity, the better the gelling capability of the system.

The measured curves obtained were used to determine, by interpolation, for each plastisol the temperatures at which a complex viscosity of 1000 Pa*s or 10 000 Pa*s was reached. Additional parameters determined using the tangent method were the maximum plastisol viscosity achieved in the present experimental set-up, and also, by dropping a perpendicular, the temperature above which maximum plastisol viscosity occurs.

### 4. Production of Foam Sheets and Determination of Expansion Rate

Foaming behaviour was determined using a thickness gauge suitable for plasticized PVC measurements (KXL047 from Mitutoyo) to an accuracy of 0.01 mm. A Mathis Labcoater (type: LTE-TS; manufacturer: W. Mathis AG) was used for sheet production after adjustment of the roll blade to a blade gap of 1 mm. This blade gap was checked with a feeler gauge and adjusted if necessary. The plastisols were coated with the roll blade of the Mathis Labcoater onto a release paper (Warran Release Paper; from Sappi Ltd.) stretched flat in a frame. To be able to compute percentage foaming, first an incipiently gelled and unfoamed sheet was produced at 200° C./30 seconds' residence time. The thickness of this sheet (=Original thickness) was in all cases between 0.74 and 0.77 mm at the stated blade gap. Thickness was measured at three different points of the sheet.

Foamed sheets (foams) were then likewise produced with/in the Mathis Labcoater at 4 different oven residence times (60 s, 90 s, 120 s and 150 s). After the foams had cooled down, the thicknesses were likewise measured at three different points. The average value of the thicknesses and the original thickness were needed to compute the expansion. (Example: (foam thickness-original thickness)/original thickness*100%=expansion).

### 5. Determination of Yellowness Index

The YD 1925 yellowness index is a measure of yellow discoloration of a sample specimen. This yellowness index is of interest in the assessment of foam sheets in two respects. First, it indicates the degree of decomposition of the blowing agent (yellow in the undecomposed state) and, secondly, it is a measure of thermal stability (discolorations due to thermal stress). Colour measurement of the foam sheets was done using a Spectro Guide from Byk-Gardner. A white reference tile was used as background for the colour measurements. The following settings were used:

### Illuminant: C/2°

Number of measurements: 3

### Display: CIE L*a*b*

Index measured: YD1925

The measurements themselves were carried out at 3 different points of the samples (at a plastisol blade thickness of 200 μm for effect and flat foams). The values obtained from the 3 measurements were averaged.

The examples which follow illustrate the invention.

### EXAMPLES

### Example 1

### Production of Expandable/Foamable PVC Plastisols Containing the di-2-ethylhexyl terephthalate (DEHT) Used According to the Invention (Using Filler and Pigment)

The advantages of inventive plastisols will now be illustrated using a thermally expandable PVC plastisol containing filler and pigment. The inventive plastisols hereinbelow are inter alia exemplary of thermally expandable plastisols used in the production of floor coverings. More particularly, the inventive plastisols hereinbelow are exemplary of foam layers used as printable and/or inhibitable top-side foams in PVC floorings of multilayered construction.

The component weights used for the various plastisols are reported below in Table (1). The liquid and solid constituents of a formulation were weighed separately into a suitable PE beaker in each case. The mixture was hand stirred with a paste spatula until all the powder had been wetted. The plastisols were mixed using a VDKV30-3 Kreiss dissolver (from Niemann). The mixing beaker was clamped into the clamping device of the dissolver stirrer. A mixer disc (toothed disc, finely toothed, Ø: 50 mm) was used to homogenize the sample. For this, the dissolver speed was raised continuously from 330 rpm to 2000 rpm, and stirring was continued until the temperature on the digital display of the temperature sensor reached 30.0° C. (temperature increase due to frictional energy/energy dissipation; see for example N. P. Cheremisinoff: “An Introduction to Polymer Rheology and Processing”; CRC Press; London; 1993). It was accordingly ensured that the plastisol was homogenized with defined energy input. Thereafter, the temperature of the plastisol was immediately brought to 25.0° C.

TABLE 1
Composition of filled and pigmented expandable
PVC plastisols as per example 1. [All data in
phr (=parts by mass per 100 parts by mass of PVC)]

| Plastisol recipe | 1** | 2* |
|---|---|---|
| VESTOLIT P1352 K (from Vestolit) | 100 | 100 |
| VESTINOL ® 9 | 70 | |
| Eastman 168 | | 70 |
| Calcilit 8 G | 100 | 100 |
| KRONOS 2220 | 7 | 7 |
| Isopropanol | 3 | 3 |
| Unifoam AZ Ultra 1035 | 2.5 | 2.5 |
| Zinc oxide | 1.5 | 1.5 |

**= comparative example
*= according to invention
The materials and substances used are more particularly elucidated in what follows:
VESTOLIT P1352 K: emulsion PVC (homopolymer) having a K-value (determined according to DIN EN ISO 1628-2) of 68; from Vestolit GmbH & Co. KG
Eastman 168: di-2-ethylhexyl terephthalate; from Eastman Chemical
VESTINOL ® 9: diisononyl (ortho)phthalate (DINP), plasticizer; from Evonik Oxeno GmbH
Unifoam AZ Ultra 1035: azodicarbonamide; thermally activatable blowing agent; from Hebron S.A.
Calcilit 8G: calcium carbonate; filler; from Alpha Calcit.
KRONOS 2220: Al- and Si-stabilized rutile pigment (TiO₂); white pigment; from Kronos Worldwide Inc.
Isopropanol: cosolvent for lowering plastisol viscosity and also additive for improving foam structure (from Brenntag AG).
Zinkoxid aktiv ®: ZnO; decomposition catalyst (“kicker”) for thermal blowing agent; lowers the inherent decomposition temperature of the blowing agent; also acts simultaneously as stabilizer; for better dispersion, the zinc oxide was batched with the corresponding plasticizer (mass ratio 1:2) and ground via a 3 roll mill; from Lanxess AG

### Example 2

### Determination of Plastisol Viscosity of Filled and Pigmented Thermally Expandable Plastisols from Example 1 Following a Storage Period of 24 h (at 25° C.).

The viscosities of the plastisols produced in Example 1 were measured as described under Analysis point 2 (see above) using a Physica MCR 101 rheometer (from Anton Paar). The results are shown below in Table (2) for the shear rates 100/s and 10/s by way of example.

TABLE 2
Shearing viscosity of plastisols from
Example 1 after 24 h storage at 25° C.

| Plastisol recipe as per Ex. 1 | 1** | 2* |
|---|---|---|
| Shearing viscosity at | 9.5 | 11.4 |
| shear rate = 100/s [Pa*s] | | |
| Shearing viscosity at | 8.4 | 7.8 |
| shear rate = 10/s [Pa*s] | | |

**= comparative example
*= according to invention

Plastisol viscosities for the composition of the invention are admittedly higher, but on comparable order of magnitude to that of the comparative example. Therefore, the amount of viscosity depressant additionally needed would be limited.

### Example 3

### Determination of Gelling Behaviour of Filled and Pigmented Thermally Expandable Plastisols from Example 1

The gelling behaviour of the filled and pigmented thermally expandable plastisols obtained in Example 1 was tested as described under Analysis point 3 (see above) using a Physica MCR 101 in oscillation mode following plastisol storage at 25° C. for 24 h. The results are shown below in Table (3).

TABLE 3
Key points of gelling behaviour determined from gelling
curves (viscosity curves) of filled and pigmented expandable
plastisols obtained as per Example 1.

Plastisol recipe
(as per Ex. 1)

| | 1** | 2* |
|---|---|---|
| Reaching a plastisol | 80 | 83 |
| viscosity of | | |
| 1 000 Pa*s at [° C.] | | |
| Reaching a plastisol | 84 | 106 |
| viscosity of | | |
| 10 000 Pa*s at [° C.] | | |
| Maximum plastisol | 39 700 | 32 900 |
| viscosity [Pa*s] | | |
| Temperature on | 127 | 132 |
| reaching max. | | |
| plastisol viscosity [° C.] | | |

**= comparative example
*= according to invention

This is a further demonstration of the fact that, as also already documented in the prior art, DEHT has a worse tendency to gel than DINP.

### Example 4

### Production of Foam Sheets and Determination of Expansion/Foaming Behaviour at 200° C. Of Thermally Expandable Plastisols Obtained in Example 1

Production of foam sheets and determination of expansion behaviour were done similarly to the procedure described under Analysis point 4 except that the filled and pigmented plastisols obtained in Example 1 were used. The results are shown below in Table (4).

TABLE 4
Expansion of polymer foams/foam sheets obtained from filled and
pigmented thermally expandable plastisols (as per Ex. 6) at different
oven residence times in Mathis Labcoater (at 200° C.).

| Plastisol recipe (as per Ex. 1) | 1** | 2* |
|---|---|---|
| Expansion after 60 s [%] | 3 | 5 |
| Expansion after 120 s [%] | 332 | 359 |
| Expansion after 150 s [%] | 346 | 386 |

**= comparative example
*= according to invention

The plastisols containing the di-2-ethylhexyl terephthalate used according to the invention give higher foam heights/expansion rates after a residence time of 120 and 150 seconds compared with corresponding plastisols containing the standard plasticizer DINP. Thermally expandable plastisols comprising fillers are thus provided which, despite evident disadvantages in gelling behaviour (see Example 3), have advantages in thermal expandability.

Plastisols with fillers make it possible (despite the presence of white pigment) to discern the completeness of the decomposition of the blowing agent used and hence the progress of the expansion process from the colour of the foam obtained. The less the yellowness of the foam, the greater the degree to which the expansion process is finished. The yellowness index of the polymer foams/foam sheets obtained in Example 4, as determined in accordance with Analysis point 5 (see above), is shown below in Table (5).

TABLE 5
YI D1925 yellowness indices of polymer
foams obtained in Example 4.

| Plastisol recipe (as per Ex. 1) | 1** | 2* |
|---|---|---|
| Yellowness index after 60 s [%] | 19.5 | 20.1 |
| Yellowness index after 120 s [%] | 12.1 | 10.7 |
| Yellowness index after 150 s [%] | 12.8 | 9.9 |

The plastisols obtained on the basis of the composition of the invention have a distinctly lower colour number in the foamed state (from 120 s). The value at 60 s has practically no significance owing to the foaming which is just beginning.

Filled plastisols are thus provided which, despite evident disadvantages in gelling, allow a faster processing speed and/or lower processing temperatures with regard to foaming.

### Example 5

### Varied Degree of Filling

To further underpin the scope of the invention, a further series of tests was done with a different PVC type by varying the amounts of filler (chalk in this case) from 0 (i.e. unfilled but pigmented system) up to 133 phr (i.e. highly filled formulation). The production of plastisols and of foam sheets produced therefrom and also the determination of the expansion rate and of the yellowness indices were carried out similarly to the above examples.

TABLE 6
Recipes

| | V1 | V2 | V3 | V4 | V5 | E1 | E2 | E3 | E4 | E5 |
|---|---|---|---|---|---|---|---|---|---|---|
| Vestolit E | 100 | 100 | 100 | 100 | 100 | 100 | 100 | 100 | 100 | 100 |
| 7012 S | | | | | | | | | | |
| Calibrite | 0 | 33 | 67 | 100 | 133 | 0 | 33 | 67 | 100 | 133 |
| OG | | | | | | | | | | |
| Kronos | 7 | 7 | 7 | 7 | 7 | 7 | 7 | 7 | 7 | 7 |
| 2220 | | | | | | | | | | |
| Unifoam | 2.5 | 2.5 | 2.5 | 2.5 | 2.5 | 2.5 | 2.5 | 2.5 | 2.5 | 2.5 |
| AZ Ultra | | | | | | | | | | |
| 1035 | | | | | | | | | | |
| ZnO | 1.5 | 1.5 | 1.5 | 1.5 | 1.5 | 1.5 | 1.5 | 1.5 | 1.5 | 1.5 |
| Isopropanol | 3.3 | 3.3 | 3.3 | 3.3 | 3.3 | 3.3 | 3.3 | 3.3 | 3.3 | 3.3 |
| VESTINOL | 73 | 73 | 73 | 73 | 73 | | | | | |
| 9 | | | | | | | | | | |
| Eastman | | | | | | 73 | 73 | 73 | 73 | 73 |
| 168 | | | | | | | | | | |

V = comparative
E = inventive
Vestolit E 7012 S: emulsion PVC (homopolymer) having a K-value (determined as per DIN EN ISO 1628-2) of 67; from Vestolit GmbH & Co. KG.
Calibrite OG: mineral filler; from Omya AG GmbH

All other recipe constituents were already detailed in the first example. The foam sheets obtained in the abovementioned example were each measured for the thickness of the foamed sheet and used to compute therefrom the expansion rate in per cent.

TABLE 7
Expansion of polymer foams/foam sheets obtained from filled and
pigmented thermally expandable plastisols (as per Ex. 5) at different
oven residence times in Mathis Labcoater (at 200° C.).

| | V1 | V2 | V3 | V4 | V5 | E1 | E2 | E3 | E4 | E5 |
|---|---|---|---|---|---|---|---|---|---|---|
| VWZ | 332 | 319 | 285 | 272 | 249 | 353 | 312 | 299 | 268 | 249 |
| 1.5 min | | | | | | | | | | |
| VWZ | 332 | 316 | 299 | 301 | 284 | 389 | 355 | 351 | 318 | 319 |
| 2 min | | | | | | | | | | |
| VWZ | 350 | 335 | 315 | 305 | 289 | 357 | 347 | 322 | 315 | 292 |
| 2.5 min | | | | | | | | | | |

VWZ = residence time
All expansion rate data in percent

From the examples recited in Table 7, it is clear that the foaming behaviour of DEHT-containing compositions (E1 to E5), as expressed by the expansion rates in %, can consistently be rated better than the comparable compositions comprising the plasticizer DINP (prior art, V1 to V5).

This conclusion is further reinforced by the lower yellowness indices obtainable with the inventive compositions, see Table 8:

| | V1 | V2 | V3 | V4 | V5 | E1 | E2 | E3 | E4 | E5 |
|---|---|---|---|---|---|---|---|---|---|---|
| VWZ | 10.9 | 12.0 | 13.3 | 13.8 | 14.4 | 9.3 | 10.5 | 11.8 | 13.6 | 14.2 |
| 1.5 min | | | | | | | | | | |
| VWZ | 11.6 | 11.9 | 12.7 | 12.7 | 13.3 | 8.5 | 9.8 | 10.9 | 11.5 | 12.2 |
| 2 min | | | | | | | | | | |
| VWZ | 10.9 | 11.7 | 12.3 | 13.4 | 13.9 | 8.5 | 9.7 | 10.9 | 11.5 | 12.3 |
| 2.5 min | | | | | | | | | | |

All YI data are dimensionless

It has thus been possible to show that distinctly better results are achieved on using the compositions of the invention.

It is surprising that DENT shows these effects contrary to established textbook opinion despite the somewhat worse gelling behaviour.

1: A foamable composition comprising:
at least one polymer selected from the group consisting of polyvinyl chloride, polyvinylidene chloride, polyvinyl butyrate, polyalkyl(meth)acrylate and copolymers thereof,
a foam former, a foam stabilizer, or both, and
di-2-ethylhexyl terephthalate as a plasticizer.

2: The foamable composition of claim 1, wherein the polymer is polyvinyl chloride.

3: The foamable composition of claim 1, wherein the polymer is a copolymer of vinyl chloride with one or more monomers selected from the group consisting of vinylidene chloride, vinyl butyrate, methyl(meth)acrylate, ethyl(meth)acrylate and butyl(meth)acrylate.

4: The foamable composition of claim 1, comprising 5 to 150 parts by mass of di-2-ethylhexyl terephthalate per 100 parts by mass of polymer.

5: The foamable composition of claim 1, further comprising an additional plasticizer other than di-2-ethylhexyl terephthalate.

6: The foamable composition of claim 1, comprising the foam former, which is a gas bubble evolver component, and optionally further comprising a kicker.

7: The foamable composition of claim 1, comprising an emulsion PVC.

8: The foamable composition of claim 1, further comprising at least one additive selected from the group consisting of a filler, a pigment, a thermal stabilizer, an antioxidant, a viscosity regulator, a foam stabilizer and a lubricant.

9: (canceled)

10: A foamed moulding comprising the foamable composition of claim 1.

11: A floor covering comprising the foamable composition of claim 1, in a foamed state.

12: A wall covering comprising the foamable composition of claim 1, in a foamed state.

13: An artificial leather comprising the foamable composition of claim 1, in a foamed state.

14: The foamable composition of claim 2, comprising 5 to 150 parts by mass of di-2-ethylhexyl terephthalate per 100 parts by mass of polymer.

15: The foamable composition of claim 3, comprising 5 to 150 parts by mass of di-2-ethylhexyl terephthalate per 100 parts by mass of polymer.

16: The foamable composition of claim 2, further comprising an additional plasticizer other than di-2-ethylhexyl terephthalate.

17: The foamable composition of claim 3, further comprising an additional plasticizer other than di-2-ethylhexyl terephthalate.

18: The foamable composition of claim 4, further comprising an additional plasticizer other than di-2-ethylhexyl terephthalate.

19: The foamable composition of claim 6, comprising the kicker.

20: The foamable composition of claim 2, comprising the foam former, which is a gas bubble evolver component, and optionally further comprising a kicker.

21: The foamable composition of claim 3, comprising the foam former, which is a gas bubble evolver component, and optionally further comprising a kicker.
